(19) United States
(12) Patent Application Publication
(10) Pub. No.: US 2009/0153522 A1
(43) Pub. Date: Jun. 18, 2009

(54) FUNCTION SWITCH METHODS AND SYSTEMS

(76) Inventor: Fu-Chiang CHOU, Taoyuan County (TW)

Correspondence Address: BIRCH STEWART KOLASCH & BIRCH, PO BOX 747, FALLS CHURCH, VA, 22040-0747, US

(21) Appl. No.: 12/276,992

(22) Filed: Nov. 24, 2008

(30) Foreign Application Priority Data
Dec. 14, 2007 (TW) 96147925

(51) Int. Cl. G06F 3/042

(52) U.S. Cl. 345/175

(57) ABSTRACT

Function switch methods and systems for use in an electronic device having a touch-sensitive device are provided. First, the touch-sensitive device is touched by an input tool. Then, it is determined to switch between functions according to a force of the input tool touching the touch-sensitive device.

### CROSS REFERENCE TO RELATED APPLICATIONS

This Application claims priority of Taiwan Patent Application No. 096147925, filed on Dec. 14, 2007, the entirety of which is incorporated by reference herein.

### BACKGROUND OF THE INVENTION

1. Field of the Invention

The disclosure relates generally to function switch methods and systems, and, more particularly to function switch methods and systems that switch functions according to a touch force on a touch-sensitive device.

2. Description of the Related Art

Recently, portable devices, such as handheld devices, have become more and more technically advanced and multifunctional. For example, a handheld device may have e-mail message capabilities, an advanced address book management system, a media playback system, and various other functions. Due to increased convenience and functions of the devices, these devices have become necessities of life.

Handheld devices may provide input devices for users to control applications and/or functions. For example, a handheld device may be equipped with a touch-sensitive device for users to perform related operations. Users can slide their fingers on the touch-sensitive device, and accordingly perform related operations for respective functions. Generally, when users want to switch between functions, they must repeatedly unfold, move, and select specific items on menus to achieve the objective of switching functions. The aforementioned operations for switching between the various functions are complicated, inconvenient, and time-consuming for users. In some situations, more time is spent on switching functions than that on performing an actual operation of the function.

### BRIEF SUMMARY OF THE INVENTION

Function switch methods and systems are provided.

In an embodiment of a function switch method for use in an electronic device having a touch-sensitive device, the touch-sensitive device is touched by an input tool. Then, it is determined to switch between functions according to a force of the input tool touching the touch-sensitive device.

An embodiment of a function switch system comprises a touch-sensitive device and a processing unit. The touch-sensitive device is touched by an input tool. The processing unit is coupled to the touch-sensitive device, and determines to switch between functions according to a force of the input tool touching the touch-sensitive device.

Function switch methods and systems may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a function switch system of the invention;

FIG. 2 is a schematic diagram illustrating an embodiment of a portable device having a touch-sensitive device of the invention;

FIG. 3 is a flowchart of an embodiment of a function switch method of the invention;

FIG. 4 is a flowchart of an embodiment of a function switch method of the invention;

FIG. 5 is a schematic diagram illustrating an operation interface in a selection function; and

FIG. 6 is a schematic diagram illustrating an operation interface in a panning function.

### DETAILED DESCRIPTION OF THE INVENTION

Function switch methods and systems are provided.

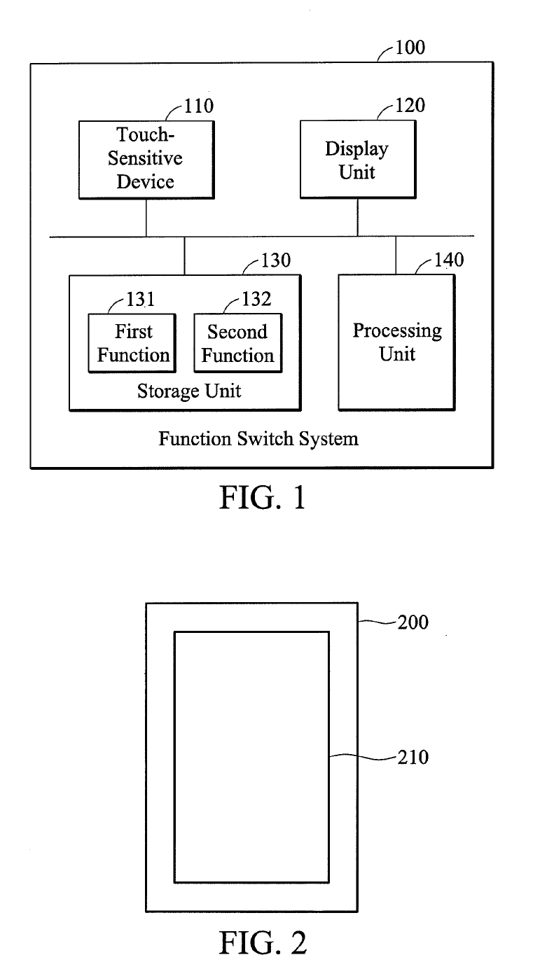

FIG. 1 is a schematic diagram illustrating an embodiment of a function switch system of the invention. The function switch system can be suitable for use in an electronic device, such as a portable device comprising a handheld device, such as a media player, a PDA (Personal Digital Assistant), a GPS (Global Positioning System) device, a smartphone, and a mobile phone.

The function switch system 100 comprises a touch-sensitive device 110, a display unit 120, a storage unit 130, and a processing unit 140. The touch-sensitive device 110 comprises a touch-sensitive surface having at least one sensor in at least one dimension to detect the contact and movement of an input tool, such as a finger or a stylus thereon. The display unit 120 displays operation interfaces corresponding to various functions and related information. In some embodiments, the touch-sensitive device 110 and the display unit 120 can be integrated as a touch panel 210 set on a portable device 200, as shown in FIG. 2. The storage unit 130 comprises at least a first function 131 and a second function 132. In some embodiments, respective functions can provide operations in different modes for an application. For example, functions may comprise a selection function and a panning function. Additionally, the storage unit 130 may store related information, and provide the information to the display unit 120 for display. The processing unit 140 performs the function switch methods of the application, which will be discussed further in the following paragraphs.

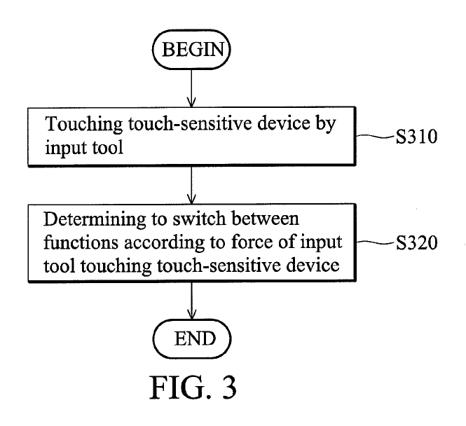

FIG. 3 is a flowchart of an embodiment of a function switch method of the invention. The function switch method is used for an electronic device having a touch-sensitive device.

In step S310, the touch-sensitive device is touched by an input tool, such as a finger or a stylus. Then, in step S320, it is determined to switch between functions according to a force of the input tool touching the touch-sensitive device.

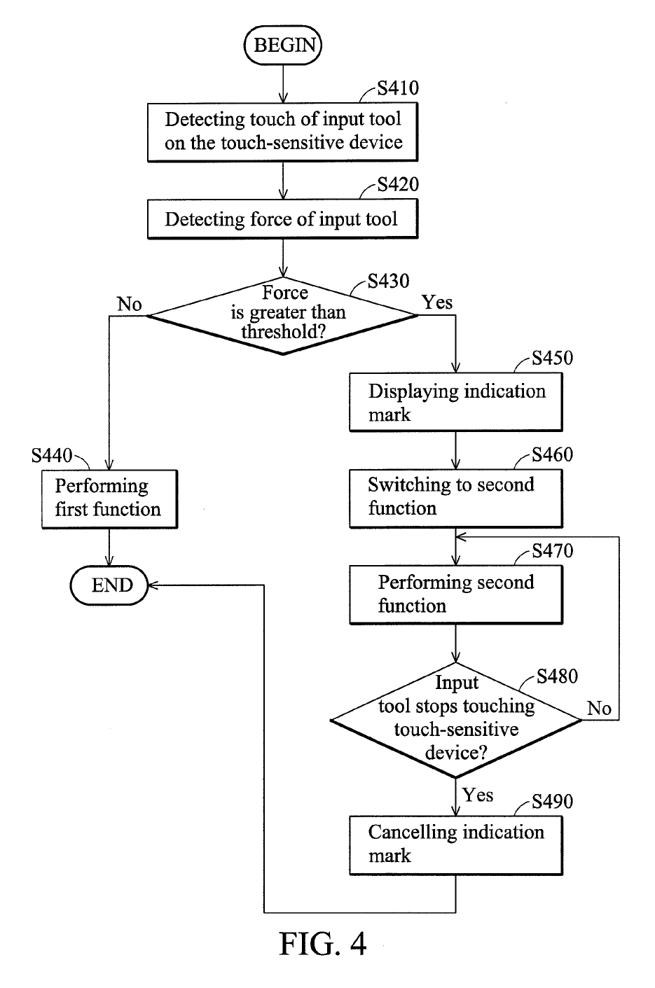

FIG. 4 is a flowchart of an embodiment of a function switch method of the invention. The function switch method is used for an electronic device having a touch-sensitive device.

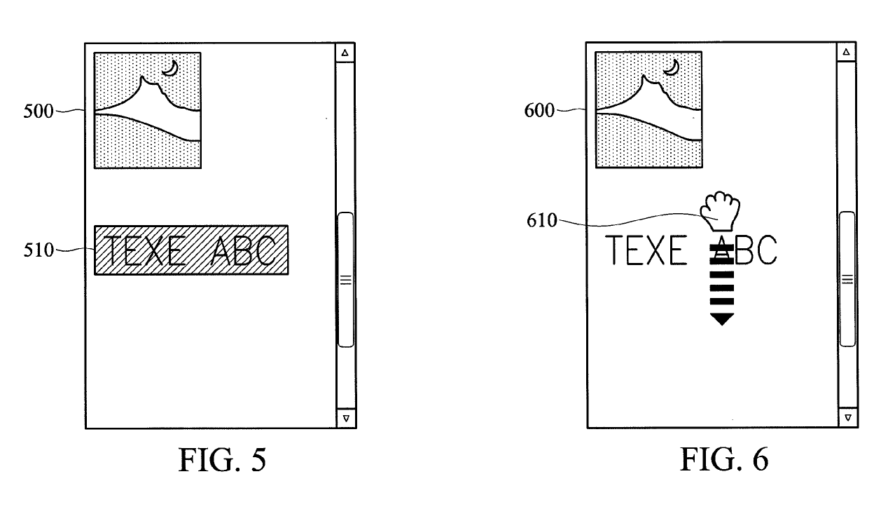

In step S410, a touch of an input tool on the touch-sensitive device is detected, and in step S420, a force of the input tool touching the touch-sensitive device is detected. Then, in step S430, it is determined whether the force is greater than a threshold. It is understood that the detection of the force of the input tool touching the touch-sensitive device can be achieved in various manners. In some embodiments, a pressure corresponding to the force on the touch-sensitive device can be detected. When the pressure is greater than a predefined pressure, the force is greater than the threshold. In some embodiments, a touch area of the input tool touching the touch-sensitive device can be detected. When the touch area is greater than a predefined area, the force is greater than the threshold. In some embodiments, a total current value generated when the input tool touches the touch-sensitive device can be detected. When the total current value is greater than a predefined current value, the force is greater than the threshold. It is noted that the above detections of the force of the input tool touching the touch-sensitive device are examples of the application, and the application is not limited thereto. When the force is not greater than the threshold (No in step S430), in step S440, a first function, such as the selection function is performed. FIG. 5 is a schematic diagram illustrating an operation interface in a selection function. In the selection function, users can use the input tool to slide on the touch-sensitive device, thus to select texts from the operation interface 500, such as the highlighted text block 510 in FIG. 5. When the force is greater than the threshold (Yes in step S430), in step S450, an indication mark is displayed in the display unit, and in steps S460 and S470, a second function, such as the panning function is switched to and performed. FIG. 6 is a schematic diagram illustrating an operation interface in a panning function. As shown in FIG. 6, an indication mark 610 representing the current function is the second function is shown on the operation interface 600. In the panning function, users can use the input tool to slide on the touch-sensitive device, thus to move the entire operation interface 600. In step S480, it is determined whether the input tool stops touching the touch-sensitive device (the input tool leaves the surface of the touch-sensitive device). If the input tool does not stop touching the touch-sensitive device (No in step 8480), the procedure returns to step S470. If the input tool stops touching the touch-sensitive device (Yes in step S480), in step S490, the indication mark is cancelled, and the procedure is completed. In this embodiment, when the second function is performed, the force of the input tool touching the touch-sensitive device is not detected. When the input tool stops touching the touch-sensitive device, the indication mark is cancelled. When the input tool touches the touch-sensitive device again, the force of the input tool touching the touch-sensitive device during the most recent touch is further detected, and it is determined to perform the first function or the second function accordingly.

It is understood that, in some embodiments, the electronic device can initially perform the first function, and then proceed with the detection of the touch corresponding to the input tool. After the second function is switched to from the first function, when the input tool stops touching the touch-sensitive device, the first function can be directly switched to from the second function. Further, in some embodiments, when the first function is performed, the detection of the force of the input tool touching the touch-sensitive device can be continuously detected. It is determined whether the force is greater than the threshold. If the force is greater than the threshold, the second function can be immediately switched to from the first function. Additionally, in some embodiments, when the second function is performed, the detection of the force of the input tool touching the touch-sensitive device can be continuously detected. It is determined whether the force is greater than the threshold. If the force is not greater than the threshold, the first function can be immediately switched to from the second function.

Therefore, the function switch methods and systems of the application can switch functions according to the touch force on the touch-sensitive device.

Function switch methods and systems, or certain aspects or portions thereof may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiling or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A function switch method for use in an electronic device having a touch-sensitive device, comprising:
touching the touch-sensitive device by an input tool; and
determining to switch between a first function and a second function according to a force of the input tool touching the touch-sensitive device.

2. The method of claim 1, further comprising:
detecting the force;
determining whether the force is greater than a threshold; and
when the force is greater than the threshold, switching to the second function from the first function.

3. The method of claim 2, wherein after the second function is switched to, the force is not detected, and when the input tool stops touching the touch-sensitive device, a performance of the second function is stopped.

4. The method of claim 2, further comprising:
when the force is not greater than the threshold, keeping a performance of the first function; and
when the force is greater than the threshold, displaying an indication mark in a display unit.

5. The method of claim 4, further comprising when the input tool stops touching the touch-sensitive device, canceling the indication mark.

6. The method of claim 2, wherein the step of detecting the force is achieved by detecting a pressure corresponding to the force on the touch-sensitive device, wherein when the pressure is greater than a predefined pressure, the force is determined to he greater than the threshold.

7. The method of claim 2, wherein the step of detecting the force is achieved by detecting a touch area of the input tool touching the touch-sensitive device, wherein when the touch area is greater than a predefined area, the force is determined to be greater than the threshold.

8. The method of claim 2, wherein the step of detecting the force is achieved by detecting a total current value generated when the input tool touches the touch-sensitive device, wherein when the total current value is greater than a predefined current value, the force is determined to be greater than the threshold.

9. The method of claim 1, wherein the first function is a selection function, and the second function is a panning function.

10. A function switch system for use in an electronic device, comprising:
a touch-sensitive device to be touched with an input tool; and
a processing unit coupled to the touch-sensitive device, determining to switch between a first function and a second function according to a force of the input tool touching the touch-sensitive device.

11. The system of claim 10, wherein the processing unit further detects the force, and determines whether the force is greater than a threshold, and when the force is greater than the threshold, switches to the second function from the first function.

12. The system of claim 11, wherein after the second function is switched to, the processing unit does not detect the force, and when the input tool stops touching the touch-sensitive device, the processing unit stops a performance of the second function.

13. The system of claim 11, wherein when the force is not greater than the threshold, the processing unit continues a performance of the first function, and when the force is greater than the threshold, the processing unit further displays an indication mark in a display unit.

14. The system of claim 13, wherein when the input tool stops touching the touch-sensitive device, the processing unit further cancels the indication mark.

15. The system of claim 11, wherein the detection of the force is achieved by detecting a pressure corresponding to the force on the touch-sensitive device, wherein when the pressure is greater than a predefined pressure, the force is determined to be greater than the threshold.

16. The system of claim 11, wherein the detection of the force is achieved by detecting a touch area of the input tool touching the touch-sensitive device, wherein when the touch area is greater than a predefined area, the force is determined to be greater than the threshold.

17. The system of claim 11, wherein the detection of the force is achieved by detecting a total current value generated when the input tool touches the touch-sensitive device, wherein when the total current value is greater than a predefined current value, the force is determined to be greater than the threshold.

18. The system of claim 10, wherein the first function is a selection function, and the second function is a panning function.

19. A machine-readable storage medium comprising a computer program, which, when executed, causes a device to perform a function switch method, and the method comprising:
detecting a touch on a touch-sensitive device by an input tool; and
determining to switch between a first function and a second function according to a force of the input tool touching the touch-sensitive device.
